(19) United States
(12) Patent Application Publication
(10) Pub. No.: US 2012/0261470 A1
(43) Pub. Date: Oct. 18, 2012

(54) METHOD AND SYSTEM FOR THE PROTECTION OF VOTING OPTIONS FOR REMOTE VOTING

(75) Inventors: Pere Vallés Fontanals, Barcelona (ES); Pablo Sarrias Bandres, Molins de Rei (Barcelona) (ES); Jordi Puiggali Allepuz, Sant Cugat del Valles (ES); Sandra Guasch Castello, Sant Agusti (Eivissa) (ES)

(73) Assignee: SCYTL SECURE ELECTRONIC VOTING, S.A., Barcelona (ES)

(21) Appl. No.: 13/420,674

(22) Filed: Mar. 15, 2012

Related U.S. Application Data
(63) Continuation-in-part of application No. 13/036,491, filed on Feb. 28, 2011.

(51) Int. Cl. G07C 13/00

(52) U.S. Cl. 235/386

(57) ABSTRACT

The method uses a computer voting selection application suitable for execution in a remote environment by a remote user for obtaining in a local site a marked ballot from the voting selections made by the remote user. It includes generating using a remote voting computer an element representing in a machine readable format an information of the voting selections made by the remote user, recording this machine readable element in a first physical support, and sending this first physical support through a physical delivery channel to the local site where the machine readable element from the physical support is read using a reading device, and the voting selections made by the remote user are retrieved using a retrieving computer. A record representing the remote user voting selections retrieved is then obtained and processed by an electronic counting device that counts voting selections from images obtained from the obtained record.

### CROSS-REFERENCE TO RELATED APPLICATIONS

This application is a Continuation-in-Part Application of U.S. patent application Ser. No. 13/036,491, filed Feb. 28, 2011, the contents of such application being incorporated by reference herein.

### FIELD OF THE INVENTION

The present invention relates in a first aspect to a method for using a voting computer to generate an element that contains a machine readable representation of the information about the voting selections made by the voter, which can be transmitted to a remote location.

This generated element allows the reconstruction of a record in a retrieving computer by means of a reading device that represents these voting selections in such a way that it can be processed by an optical scanner counter comprised by a scanning device and an electronic counting device. The record can either be represented in a physical format (e.g. a paper ballot by using a printing device attached to the retrieving computer), so that the physical ballot is scanned prior to being processed by the electronic counting device, or in a digital format (e.g. an image), and then is processed by the electronic counting device, which counts voting selections from images.

The invention further discloses a system to implement the preferred method.

### BACKGROUND OF THE INVENTION

Absentee ballots are used in elections to allow registered voters to cast their ballots remotely. Therefore, some states have provisions for emailing ballots, faxing ballots, or delivering them in person to a designated location.

However, the delivery process and counting of these ballots are not free from errors that could prevent the processing of cast votes. To this end, several proposals have been focused on reducing these issues with more or less success. The proposal of the method and system described in this invention is to solve all these issues, including the ones not yet solved by other proposals. Below we will analyze the different problems, how are they managed by the currently existing solutions and how the proposal of this invention covers the gaps not yet solved by these solutions.

### Blank Ballot Delivery by Mail

The absentee ballots are usually sent initially by post to the voters. This process is usually called blank ballot delivery. Then, the voter marks her voting selections in the blank ballot and mails it back to her State election officials for its counting. Once the marked absentee ballots are received in the central election offices, they are counted either manually or electronically.

However, this system presents several problems:

Blank ballot delivery on time: one of the most challenging issues in absentee voting is how to bring the ballots to the absentee voters on time. The initial blank ballot delivery time depends on the deadline for the addition of candidates or questions to the ballot, and it is usually close to the start of the voting period. Therefore, postal mail is not always fast enough to deliver the ballots on time for filling and mailing them back to the state in the time period assigned to the absentee voting process. In fact, several times, absentee ballots have not been accepted in the vote recount for arriving late. Therefore, absentee voters are disenfranchised.

Manual marking of optical scanner votes: usually, most States use optical scanning for electronic counting of in person votes. Furthermore, the electoral law forces them to use the same counting system for absentee voters. Therefore, in these cases, election officers need to count the absentee ballots thought optical scanners. Postal votes cannot be directly fed into the optical scanners since they are folded inside the envelope (folded sheets tend to stuck in optical scanners). Therefore, electoral officers are in charge of manually copying the voting selections coming from these absentee votes to the optical scanner compatible votes. This leads to the possibility of human errors or malicious electoral officers modifying the contents of the absentee votes.

Invalid votes due to voter mistakes: the blank ballot is manually marked, and it is not checked after the time of counting. Therefore, the voter cannot be warned while filling the ballot in case she is making any mistake that could invalidate it (e.g. under-voting or over-voting). The result is that a considerable amount of absentee votes are invalidated and the voter it is not aware about it.

Therefore, alternative absentee ballot delivery methods have been introduced recently, like the electronic blank ballot delivery, or the online ballot marking.

### Electronic Blank Ballot Delivery

In the electronic blank ballot delivery proposal, the voter accesses to a web service to download her blank ballot in an electronic format. Then, voter prints the blank ballot and manually fills in. The mailing back and counting process is the same than in the mail blank ballot delivery system.

This system solves the problem of the blank ballot delivery on time, but it does not address issues on the manual marking of optical scanner votes or having absentee invalid votes due to voter mistakes.

### Online Ballot Marking

In case of online ballot marking, the voter accesses to a web application that displays the voting options and guides her through the process of making her voting selections. At this point, the marked ballot is printed in paper to mail or fax it back to the state.

This system solves the problems of blank ballot delivery on time and prevention of voter mistakes while filling the ballot. Regarding the manual marking of the votes to be read in optical scanners, despite there are some proposals in this area, none of them solve this issue.

The Open Voting Consortium [1] and EveryoneCounts [2] propose a system for electronic ballot marking that prints the marked ballot in paper and attaches a bar code representing the voting options. After the voting phase, the barcodes of these votes are read with a barcode reader to perform an electronic count, but in any case they are proposing any method for creating a vote that can be processed by an optical scanner. Therefore, these systems cannot be used in the States were election officers need to count the votes using optical scanning. Furthermore, the format of the ballot is not the same as the ones cast in polling stations. Therefore, they are distinguishable from these votes in a manual counting process.

In the state of the art, there are other proposals, like AutoMark (U.S. Pat. No. 7,753,273) or Populex (U.S. Pat. No. 7,306,148), that provide an electronic interface for ballot marking and printing of votes in a format suitable to be read by an optical scanner. However, these proposals are related to specific devices designed to be used in polling places. Therefore, these solutions cannot be used in absentee voting processes since they cannot be distributed to voters (i.e., they have a standalone architecture).

The object of the present invention is a ballot marking method suitable to be used in a voting computer by an absentee voter that generates an element that represents the voting options in a machine readable format that may be recorded in a physical media, such as a printed bar code. On the reception in the election central office, the information of this element is used for generating a ballot (in the form of a sheet of paper or a digital image) that is suitable for being processed by an optical scanner counter or manual counting. The difference with the existing proposals is that the information of this element (e.g., bar code contents) is not processed for generating a result, but for generating a ballot that can be counted by the same automated means (e.g., optical scanning counter machines) used for counting the paper ballots from the rest of the voters.

In a preferred implementation, the generated ballot is a paper ballot with exactly the same appearance as the ballots from non-absentee voters.

In an alternative implementation the information of this generated element is used for generating a digital image containing the voter voting selections, which is suitable to be processed by the optical scanner counter as well. This way, absentee votes can still be counted by the same way than ballots from the rest of the voters without the need of printing them.

### SUMMARY OF THE INVENTION

Accordingly, it is an object of the present invention to provide a method for casting a vote from a remote location containing the voting selections made by a voter by electronic means (e.g., an absentee voter casting a vote using her own computer), that facilitates the final counting of these voter voting selections using the same counting means as regular votes marked by hand.

The proposed method allows obtaining in a local site a marked ballot from the voting selections made by a remote user, by means of a computer voting selection application suitable for execution in a remote environment, said local site being selected among a central office or another place managed by electoral officers.

The method comprises following steps:

a) generating using a remote voting computer an element representing in a machine readable format at least an information of one or more voting selections made by the remote user and making use of said remote voting computer to record this machine readable element in a first physical support (such as a printed sheet) and sending this first physical support through a physical delivery channel (such as a postal service) to said local site;

b) receiving the physical support in said local site, reading the machine readable element from the said physical support using a reading device, and retrieving the voting selections made by said remote user from the reading process using a retrieving computer;

c) obtaining a record representing the remote user voting selections retrieved in the step b), and

d) processing said record by an electronic counting device that counts voting selections from images acquired from said obtained record.

In a first embodiment the record representing the remote user voting selections obtained in step c) is a printed marked ballot that is processed in said electronic counting device by means of an associated scanning apparatus which scans said printed marked ballot before said counting of the voting selections from images.

The cited printed marked ballot is obtained by printing said voting selections and a blank ballot template in a blank sheet or as marks in the checkboxes of a printed blank ballot, using a printing device.

In an alternative embodiment said record representing the remote user voting selections obtained in step c) is a digital image that is processed by said electronic counting device which counts the voting selections from said digital image.

The remote voting computer is also used for additionally generating and recording in step a) a human readable representation of at least said user voting selections in the same first physical support or in a different second physical support and sending both first and second physical supports by means of said physical delivery channel to said local site.

The remote voting computer is also used for additionally generating in step a) an electronic representation of the user voting options, being this electronic representation sent through an electronic communication channel to a voting server located in a central office or other place managed by electoral officers.

The method also introduces optional audit processes that are focused to detect any ballot representation problems that could generate a vote that does not really reflect the real intent of the voter. To this aim step c) can further comprising an additional process in which the voting selections made by the remote user, represented in a human form or in an electronic form (sent in step a)) are compared with the record representing the voting selections made by the remote user obtained in step c), determining from said comparison the representation validity of said obtained record.

According to the method of this invention the remote voting computer is further used to encode (e.g., by means of symmetric or asymmetric encryption) the information included in the electronic representation of the voter voting selections before sending it. In this case, these contents can only be processed by the receiver (since it should be the only one that has the decryption key).

As a preferred embodiment a barcode is used as the representation of said machine readable element that represents the voting selections made by the remote user.

The remote voting computer can also be used for further encoding in step a) the information of the voter voting selections before generating said machine readable element representing this information and in this case the retrieving computer is used to decode in step b) the information encoded in step a) after it has been read with a reader device (such a barcode reader), and before retrieving the voting selections made by the remote user from the decoded information. The encoding in step a) of the information of said voter voting selections can be performed using a compression function and/or an encryption function.

In case the element generated in step a) is represented as a barcode, the reading process will consist on using a barcode scanner for processing the contents. In case the information is encoded, the method also introduces several ways for decoding the information in a safe way using a retrieving computer. For instance, this method proposes the use of secret sharing schemes or multi-party computation techniques to enforce the collaboration of several actors in the decryption process. Further details are following disclosed.

In a further development this method comprises further storing in step b) a copy of the retrieved voting selections made by said remote user in a storage media connected to said at least one retrieving computer.

### BRIEF DESCRIPTION OF THE DRAWINGS

FIG. 1 identifies the main elements and processes of the method executed by the voter, using as reference a preferred embodiment that uses a postal delivery channel:

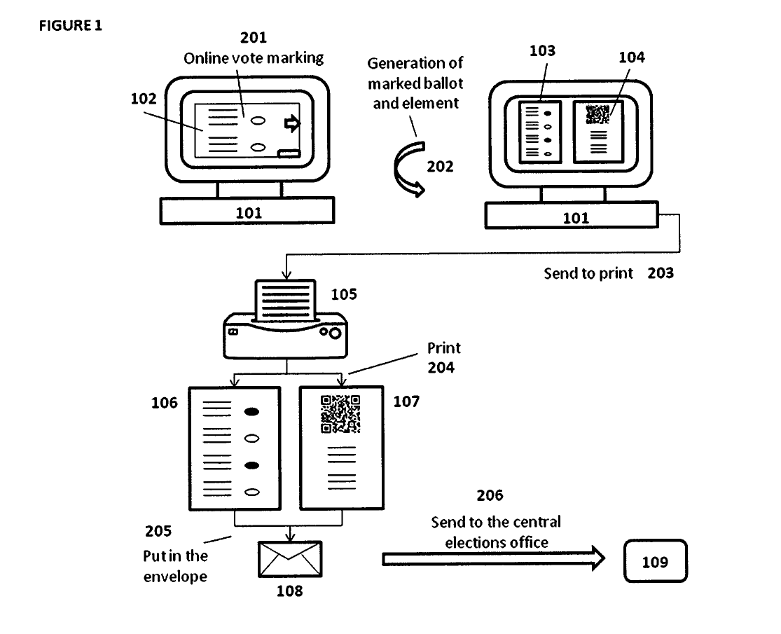

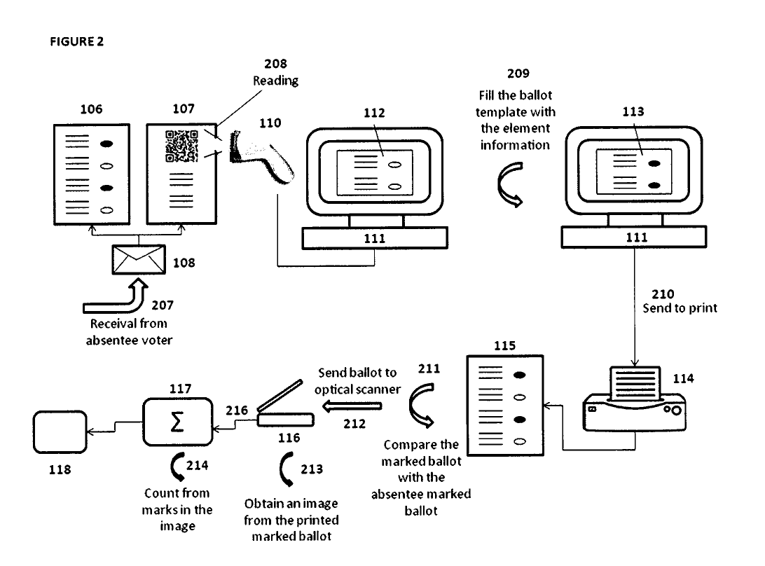

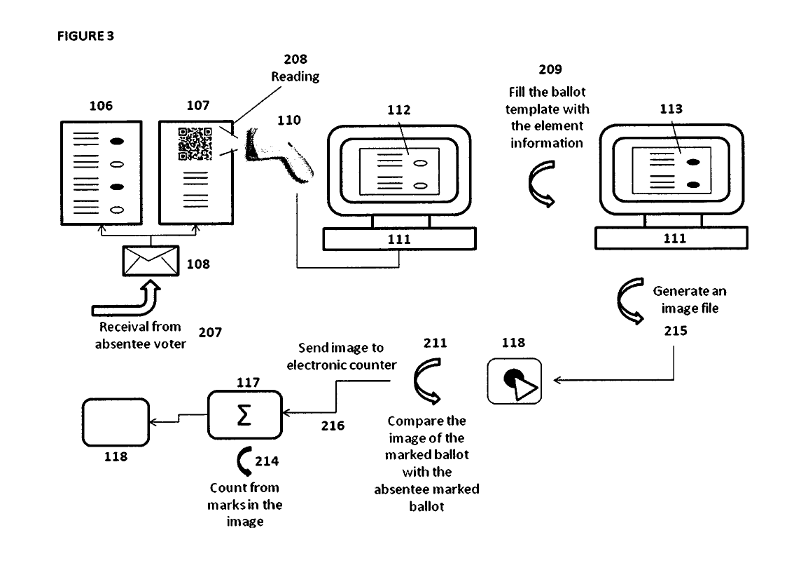

a) The absentee voter uses an online computer voting selection application 102 running in a remote voting computer 101 to fill in 201 her ballot.
b) Once the voter has selected all the options, the electronic marked ballot 103 and an element that represents (in a machine readable format) the voter voting selections 104 are electronically generated 202 in the remote voting computer 101.
c) The element representing the voter voting selections 104 and optionally the electronic marked ballot 103 are sent 203 to the printer 105, where an element representing the voter voting selections 107 and optionally a marked ballot 106 are printed 204.
d) The element representing the voter voting selections 107 and optionally the printed marked ballot 106 (if printed) are sent 206 to the central elections office 109, for instance using 205 a postal envelope 108.

FIG. 2 identifies the main elements and processes of the method executed by the election officers at the central elections office, using as reference a preferred embodiment that uses a postal delivery channel, a barcode to represent the voting selections, and the generation of a printed marked ballot:

a) When the envelope 108 sent by the absentee voter is received 207, the element representing the voting selections 107 is read 208 with a bar code reader 110 connected to a retrieving computer 111.
b) The voter voting selections obtained from the reading process 208 are used to fill in 209 a ballot template 112 in the retrieving computer 111 obtaining an electronic marked ballot 113.
c) The electronic marked ballot 113 is sent 210 to a printer 114 to be printed.
d) The printed marked ballot 115 is optionally compared 211 with the absentee printed marked ballot 106 if this one has been received. If the comparison is not successful, the method can be aborted in this step and the element containing the voting selections 107 may be put under a further audit process. In case the comparison is successful, the process continues:
e) The printed marked ballot 115 is sent 212 to the scanning device 116, where a digital image of said ballot is obtained 213 by the scanning process.
f) Finally, the digital image is fed 216 into an electronic counting device, which counts selections from images 117, where the voter voting selections are read and accumulated with the actual count 214 (vote count) in order to obtain the election results 118.

FIG. 3 identifies the main elements and processes of the method executed by the election officers at the central elections office, using as reference an embodiment that uses a postal delivery channel and the generation of a digital image of a marked ballot:

a) When the envelope 108 sent by the absentee voter is received 207, the element representing the voting selections 107 is read 208 with a bar code reader 110 connected to a retrieving computer 111.
b) The voter voting selections obtained from the reading 208 process are used to fill in 209 a ballot template 112 in the retrieving computer 111 obtaining an electronic marked ballot 113.
c) A digital image 119 of the electronic marked ballot 113 is obtained 215 in the retrieving computer 111.
d) The digital image 119 is optionally compared 211 with the absentee printed marked ballot 106 if this one has been received. If the comparison is not successful, the method can be aborted in this step and the element containing the voting selections 107 may be put under a further audit process. In case the comparison is successful, the process continues:
e) Finally, the digital image is fed 216 into an electronic counting device 117 which counts selections from images, where the voter voting selections are read and accumulated with the actual count 214 (vote count) in order to obtain the election results 118.

### DETAILED DESCRIPTION OF THE INVENTION

It is an object of the present invention to provide a method for casting a vote from a remote location containing the voting selections made by a voter by electronic means (e.g., an absentee voter casting a vote using her own computer), that facilitates the final counting of these voter voting selections using the same counting means as regular votes marked by hand.

The proposed method allows obtaining in a local site a marked ballot from the voting selections made by a remote user, by means of a computer voting selection application suitable for execution in a remote environment, said local site being selected among a central office or another place managed by electoral officers.

The method comprises steps a) to d) above explained.

The following sections describe in more detail the phases of the object of the invention:

1. Generation and sending of an element that represents in a machine readable format the information of the voting selections made by a remote user;

The method assumes the existence of an electronic voting application running in a voting computer that initially captures the remote user or voter intent before proceeding with the vote casting process. Therefore, the voter intent captured by this voting application (consisting on at least a set of voter voting selections) is used by the method described in this invention for casting and counting a vote.

This electronic voting application can be any application known from the current state of the art, such as a standalone computer program or a web based application, or any future implementation that copes with the same objective of capturing voter voting selections. For instance, in the case of absentee voters, this electronic voting application can be an online ballot marking system that guides the voter through the vote voting selection process and captures the voter voting selections in an electronic form. This online ballot marking system can be a web based application accessed by the voter using her own computer at home.

After the voter intent has been captured by the application, the proposed method starts generating in the voting computer an element that represents at least the voting options selected by the voter. This element represents in a machine readable format the information of the voter voting selections for allowing the automatic processing of the element contents by a machine (e.g., a barcode scanner). The machine readable element is then recorded or printed in a first physical support (e.g. using a printing device), allowing its delivery through a physical channel, such as a postal service.

Optionally, in addition to the machine readable element, a human readable representation of the voter voting selections generated by the said voting computer can be recorded or printed in the same first physical support or in a second physical support, which is sent together with the first physical support by the same physical channel. Therefore, this option allows any person to audit by human means (e.g., reading) the proper interpretation of the information contained in the machine readable element by any machine by comparing the information obtained from the element with the human readable representation of the voter voting selections.

Another option of the proposed invention consists on using the voting computer for encoding the voter voting selections before generating their representation in a machine readable format. This encoding can be done using compression, encryption, or a combination of both. In case of data compression, any algorithm known from the current state of the art or equivalent can be used, such as a ZIP or GZIP formatting function. In case of data encryption, any symmetric or asymmetric algorithms can be used, such as AES, RSA, ElGamal or any based on Elliptic Curves.

In a preferred embodiment, the representation of the voter voting selections is alphanumerical, such as the name of the option or question and the one or more selected responses or preferences. For instance, the representation can be a set of attribute and value pairs such as:

question1=response_{—}1, question2=response_{—}2, . . . , question_n=response_n

This alphanumerical representation can be also formatted using known formatting methods, such as XML, SML, ASN1, CSV or any other possible data representation format.

In a second preferred embodiment, the voting computer is used to generate an element representing the voter voting selections using a format susceptible of being printed or recorded in a physical media (e.g., a barcode). In this case, the said element contains, in addition of the representation of the voter voting selections, other recovery information. This recovery information allows the reconstruction of the original voter voting selections represented by the element in case the printed or recorded representation of the element is partially damaged. Examples of these types of element representation are any 1 or 2 dimension barcode, such as a PDF417.

In any of the preferred embodiments, a human readable representation of the element contents can be optionally generated using the voting computer and printed in or attached to the physical media that contains the machine readable element. Therefore, the voter could verify if the human readable version of the options corresponds to his/her intent before sending them to a central election office.

In an alternative embodiment, in addition of sending the physical media with the machine readable element, an electronic representation of the voter voting selections is also generated by the voting machine. This electronic representation can be generated by using the same voting application used to capture the voting selections or any other application connected to the former. The electronic representation can be stored in the same machine that executes the voting application (the voting machine) or can be sent through a networked server through a communication network (e.g. sent to a voting server located in a central election office or in another place managed by electoral officers). In any of these cases, the electronic representation of the votes can be encoded before being stored or delivered. If so, any of the proposals described to encode the machine readable representation of the element can be used (i.e., compression or encryption).

2. Receiving the physical support in the local site, reading the machine readable element from the physical support, and retrieving the original voting selections made by the voter.

In this phase the element is received in the local site (e.g., central election office or another place managed by electoral officers, like the State Board of Elections office).

After the reception, the machine readable element is read from the physical support using a reading device connected to a retrieving computer, to recover the information about the voter voting selections. This device could be a barcode reader (connected to a computer or handheld device), an optical scanner or any other system that is able to interpret the format in which the element has been recorded or printed in the physical media.

For instance, in the preferred embodiment introduced before in which the element is represented using a 1D or 2D barcode, the device could be a barcode scanner or optical scanner.

The reading process can be implemented in a supervised or automated form. If the process is supervised, a person (e.g., operator) will operate the device for reading each individual physical media. When the process is automated, the physical support can be introduced in groups or batches in the device that reads them without requiring supervision.

The contents of the machine readable element (i.e., the voter voting selections) are then stored in an electronic format in a retrieving computer for the processing in the next phase of this method. Alternatively, the retrieved information or a copy of it can be stored in medium/long term storage media for future processing.

In case the retrieved information was encoded, the retrieving computer can be also used to decode this information before being stored or processed by the next step of the method. The decoding process can be managed by the same operator, another privileged person or could require the collaboration of several persons for the complete decoding. In case it is required the participation of several persons for the decoding, a cryptographic secret sharing scheme or secure multi-party computation method can be used to force this collaboration. Multiple examples of these schemes or methods can be obtained from the current state of the art, such as the Shamir secret sharing scheme.

3. Obtaining a record representing the remote user voting selections retrieved in step 2.

In this step, the electronic representation of the voter voting selections is recorded in a specific media such that the vote can be counted in the same way than votes cast by regular voters.

In a first embodiment, the record representing the remote voter voting selections is a printed marked ballot. This printed ballot is obtained by printing the voter voting selections obtained in the step 2 jointly with a ballot template in a blank sheet. The blank sheet and the ballot template are such that the printed marked ballot is suitable to be counted by the same electronic counting device used to count votes cast in person. In an alternative embodiment where the voter voting selections retrieved from the element are printed over a printed blank ballot the resulting printer marked ballot is also suitable to be counted by the same electronic counting device used to count votes cast in person.

This printing process can be implemented in a printing device attached to the retrieving machine used to get the information about the voter voting selections, or in a different machine (i.e., a second retrieving computer) that has access to the information read by the reading device. This information access link between the (first) retrieving computer and the second retrieving computer can be based on using shared storage means (network disk), removable media (pen drive, CD or removable disk unit) or a network communication service for interchanging information through a LAN/WAN connection (FTP, Web, Mail, etc.).

The printing process can be also done just after each machine readable element from a physical media has been read instead of waiting for reading all of them.

In second embodiment, the electronic representation of the voter voting selections in the retrieving machine is used to generate a digital image file, being this image suitable to be processed by the same electronic counting device used to count the votes cast in person. The image generated in the retrieving computer may have a format suitable to be processed by the electronic counting device (i.e. .jpg, .gif, .bmp, .pdf, etc.).

As an optional step, if the voter also delivered a human readable version of the voting selections, a retrieving machine operator or an authorized person could compare the generated record (either the printed ballot or the ballot digital image) with the human readable information. This process will allow ensuring that the generated records contain exactly the same voter voting selections as the human readable versions sent by the voters. In case there are divergences, the generated record could be discarded. This verification is interesting, since during the transport process after voter delivery, the physical media containing the machine readable representation could be damaged. Therefore, the reader device and the retrieving computer could retrieve wrong information from the representation or no information at all. To reduce the risk of retrieving wrong or no information, the use of barcodes o similar formats is recommended, since they contain recovery information. This optional step also allows detecting discrepancies between the original selected voting options and the ones retrieved by the machine reading process.

This step can be done for all the physical media received from the voters. In this case, the verification can be done by comparing the human readable voting selections of the received first or second physical media, and the contents of the record generated from the machine readable element of the first physical media. This verification can be done one by one or by groups. When done by groups, the verification is done based on checking the overall selected options from all the received media all together instead one by one.

Finally, the verification process can be done under a defined percentage of the received media. In this case, the specific percentage could be based on any legal requirement that applies to the counting process.

In case the remote voter also generated and cast an electronic representation of the voter voting options, so that they are received in the local site through a communication network, this electronic representation can be also used to audit the proper interpretation of the machine readable element contents by comparing the information about the voter voting selections retrieved from the machine readable element with the information about the voter voting selections received in the electronic representation. All the options presented for the human readable version of the voter voting selections to proceed to this comparison can be applied to audit the contents of the machine readable elements using the electronic representation of the voter voting options.

4. Processing the record obtained in step 3 by an electronic counting device that counts voting selections from images acquired from said obtained record.

In the final step, the records representing the voters' voting selections obtained in step 3 are processed by an electronic counting device in order to obtain the election results. This electronic counting device is such that it is the same used to count regular votes marked by hand.

In a preferred embodiment, the electronic counting device is an optical scanner counter comprised by a scanning device and an electronic counting device that counts selections from images.

In a specific embodiment where the records representing the information obtained from the machine readable elements, obtained in step 3, are printed marked ballots, these records are processed by the scanning device in order to obtain digital images from them (for example, a digital image for each marked ballot). The format of these digital images may be .jpg, .gif, .pdf or whatever format is suitable to be used by the electronic counting device counting voting selections from images.

In case the records representing the information obtained from the machine readable elements, obtained in step 3, are ballot digital images, they do not have to be processed by the scanning device.

The electronic counting device counting voting selections from images processes the images of the printed marked ballots and the ballot image files obtained from the machine readable elements in order to obtain the voters' voting selections from said images and count them to obtain the election results. The processing may involve the use of an Optical Character Recognition (OCR) software or another software which allows the recognition of special marks or characters in images, and an accumulator which counts the selections received by each voting option.

### References Mentioned

http://www.openvotingconsortium.org/
http://www.everyonecounts.com/index.php/elections/elect_today

What is claimed is:

1. A method for obtaining in a local site a marked ballot from the voting selections made by a remote user, by means of a computer voting selection application suitable for execution in a remote environment, said local site being selected among a central office or another place managed by electoral officers, comprising the following steps of:
a) generating using a remote voting computer, an element representing in a machine readable format at least an information of one or more voting selections made by the remote user making use of said remote voting computer to record this machine readable element in a first physical support, and sending this first physical support through a physical delivery channel to said local site;
b) receiving the first physical support in said local site, reading the machine readable element from said physical support using a reading device, and retrieving the voting selections made by said remote user from the reading process using a retrieving computer;
c) obtaining a record representing the remote user voting selections retrieved in the step b), and
d) processing said record by an electronic counting device that counts voting selections from images acquired from said obtained record.

2. The method, according to claim 1, wherein said record representing the remote user voting selections obtained in step c) is a printed marked ballot that is processed in said electronic counting device by means of an associated scanning apparatus which scans said printed marked ballot before said counting of the voting selections from images.

3. The method, according to claim 2, wherein a printed marked ballot is obtained as the record representing the remote user voting selections by printing said voting selections and a blank ballot template in a blank sheet, or as marks in the checkboxes of a printed blank ballot, using a printing device.

4. The method, according to claim 1, wherein said record representing the remote user voting selections obtained in step c) is a digital image that is processed by said electronic counting device counting voting selections from images.

5. The method, according to claim 1, wherein said remote voting computer is used for additionally generating and recording in step a) a human readable representation of at least said user selected voting options in the same first physical support or in a different second physical support and sending both first and second physical supports by means of said physical delivery channel to said local site. at least one retrieving computer.

6. The method, according to claim 5, wherein step c) further comprises an additional process in which the voting selections made by the remote user, represented in a human form, sent in step a) are compared with the record representing the voting selections made by the remote user obtained in step c), determining from said comparison the validity of said obtained record.

7. The method, according to claim 1, wherein said remote voting computer is used for additionally generating in step a) an electronic representation of the user selected voting options and this electronic representation being sent through an electronic communication channel to a voting server located in a central office or other place managed by electoral officers.

8. The method, according to claim 7, wherein the remote voting computer is further used to encode the information included in the electronic representation of the selected voting options before sending it.

9. The method according to claim 7, wherein step c) further comprises an additional process in which the voting selections made by the remote user, represented in an electronic form, sent in step a) are compared with the record representing the voting selections made by the remote user obtained in step c), determining from said comparison the validity of said obtained record.

10. The method, according to claim 1, wherein a barcode is used as the representation of said machine readable element that represents the voting selections made by the remote user.

11. The method, according to claim 10, wherein a barcode reader is used as the reading device for reading the barcode representing the machine readable element.

12. The method, according to claim 1, wherein a printed sheet is used as said first physical support for recording the element that represents the voting selections made by the remote user.

13. The method, according to claim 1, wherein a postal service is used as said physical delivery channel.

14. The method, according to claim 1, wherein said remote voting computer is used for further encoding in step a) the information of the selected voting options before generating said machine readable element representing this information and the retrieving computer is used to decode in step b) the information encoded in step a) after it has been read with a reader device, and before retrieving the voting selections made by the remote user from the decoded information.

15. The method, according to claim 14, wherein said encoding in step a) of the information of said selected voting options is performed using a compression function and/or an encryption function.

16. The method, according to claim 1, wherein further storing in step b) a copy of the retrieved voting selections made by said remote user in a storage media connected to said

17. A system for obtaining in a local site a marked ballot from voting selections made by a remote user by means of a computer voting selection application suitable of being executed in a remote environment, said local site being selected among a central office or another place managed by electoral officers, the system comprising:
a) a remote voting computer capturing by means of said computer voting selection application one or more voting selections made by a remote user, generating an element that represents in a machine readable format at least an information of the voting selections made by said remote user and recording this element in a physical support;
b) a physical delivery channel for sending said physical support to said local site;
c) a reading device for reading said physical support;
d) at least a retrieving computer located at said local site with a generation device providing a retrieved record representing retrieved voting selections in a suitable format for further processing;
e) an electronic counting device that processes and counts said voting selections from images of said retrieved record.

18. The system according to claim 17, wherein:
said machine readable format is a barcode;
said first physical support is a sheet,
said physical delivery channel is a postal service or FAX service,
said reading device is a barcode scanner, and
said generation device is a printer.

19. The system, according to claim 17, wherein said reading device for reading said physical support includes an associated computer unit in communication with said retrieving computer and both said associated computer unit and said retrieving computer having communication or storage means for interchanging the retrieved voting selections made by the remote user.

20. The system, according to claim 17, wherein said electronic counting device includes an optical scanner that is fed by a printed ballot and an electronic counting device counting voting selections from images that is fed by the output of the optical scanner or directly by images provided by said retrieving computer.

21. The system according to claim 17, wherein further comprising a network server and an electronic communication channel between this network server and said remote voting computer, used by said remote voting computer for sending an electronic representation of the voting options selected by the remote user to the network server.
